(19) United States
(12) Patent Application Publication
(10) Pub. No.: US 2005/0120211 A1
(43) Pub. Date: Jun. 2, 2005

(54) Server apparatus, client apparatus, object administration system, object administration method, computer program, and storage medium

(75) Inventor: Hidehiko Yokoyama, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/995,273

(22) Filed: Nov. 24, 2004

(30) Foreign Application Priority Data
Nov. 27, 2003 (JP) 2003-397756

(51) Int. Cl. H04L 9/00

(52) U.S. Cl. 713/168

(57) ABSTRACT

In a server which stores and administrates objects, when an operation authority transference request to the object is received from a client terminal, an access token based on transference operation information included in the operation authority transference request is generated, and the generated access token is transmitted to the client terminal being the object of generating the operation authority transference request.

### BACKGROUND OF THE INVENTION

1. Field of the Invention

The present invention relates to a server apparatus, a client apparatus, an object administration (or management) system, an object administration method, a computer program, and a storage medium. In particular, the present invention relates to an object administration program which is administrated with respect to each authenticated user and by which various operations such as deletion, printing and the like to an object such as a document file or the like are performed, and the system which operates by using the object administration program.

2. Related Background Art

Conventionally, in an object operation system which is intensively administrated by a server, in case of enabling a third party to perform an operation to an object such as a document file or the like which is held by a specific user, it is general to first register the relevant third party as the user who can access the server and then permit the registered user to specifically perform the operation to the document file.

Besides, Japanese Patent Application Laid-Open No. 2001-101054 discloses the technique of transferring operation authority with respect to an object in a client-distributed environment. More specifically, it is disclosed in this document that authority information is first generated by one client terminal, and the generated authority information is encrypted, and the encrypted authority information is transferred to another client terminal, whereby the operation authority with respect to one object can be safely transferred from one client to another client.

However, in the above related background art, there is a problem that to perform user registration only for causing the user to temporarily perform the operation to the object is not a match for administration costs. On one hand, even in a case where the limited users such as guest users or the like who can perform the operation to the object are previously set, there is a problem that the operation authority cannot be flexibly set.

Moreover, in Japanese Patent Application Laid-Open No. 2001-101054, the access authority information is generated by the client terminal different from the server being the base of administrating the object, the generated authority information is subjected to the processes such as encryption and the like, and the processed information is transmitted. However, if the encrypted information is decrypted or deciphered by a malicious third party, there is a fear that the access authority is illegally operated.

### SUMMARY OF THE INVENTION

The present invention has been made to solve the above conventional problems, and an object thereof is to enable a third party, which is not registered in a server apparatus intensively administrating objects, to safely operate the object held by a user registered in the server apparatus.

That is, one object of the present invention is to provide a server apparatus which stores and administrates an object and operation authority information for the object, and limits that a first client terminal connected through a network performs an operation to the object on the basis of the operation authority information corresponding to a user of the first client terminal, the server apparatus comprising:
a receiving unit adapted to receive, from the first client terminal, an operation authority transference request including transference operation information indicating the content of operation authority to be transferred;
an access token generation unit adapted to generate an access token based on the transference operation information included in the operation authority transference request, in response to the reception of the operation authority transference request by the receiving unit; and
a transmitting unit adapted to transmit the access token to the first client terminal.

Another object of the present invention is to provide a terminal apparatus which can be connected to a network, comprising:
a communication unit adapted to communicate with a server apparatus through the network;
a display unit adapted to display a screen based on screen generation information received from the server apparatus by the communication unit;
an input unit adapted to input operation information including an operation authority transference operation to the screen displayed by the display unit;
an operation information transmitting unit adapted to transmit by using the communication unit the operation information input by the input unit to the server apparatus connected to the network;
a receiving unit adapted to receive an access token from the server apparatus through the communication unit;
a decryption unit adapted to decrypt the access token received by the receiving unit, by using a predetermined encryption key;
a first encryption unit adapted to encrypt authority reference information included in the access token decrypted by the decryption unit, by using a predetermined encryption key;
a second encryption unit adapted to encrypt the access token of which the authority reference information has been encrypted by the first encryption unit, by using a public key of an authority transference destination; and
an access token transmitting unit adapted to transmit the access token encrypted by the second encryption unit to a client terminal apparatus of the authority transference destination by using the communication unit.

Still another object of the present invention is to provide a client terminal apparatus which can be connected to a network, comprising:
a receiving unit adapted to receive an access token, transmitted through the network, including an access URL and an access ticket;
a decryption unit adapted to decrypt the access token received by the receiving unit, by using an own secret key; and
a transmitting unit adapted to connect to a server apparatus indicated by the access URL on the network extracted from the access token decrypted by the decryption unit and transmit the access ticket extracted from the access token to the server apparatus.

Other objects and features of the present invention will become apparent from the following description in conjunction with the accompanying drawings.

### BRIEF DESCRIPTION OF THE DRAWINGS

FIG. 1 is a view schematically showing the structure of a system according to the embodiment of the present invention;

FIG. 2 is a block diagram schematically showing the internal structure of a module group in a server shown in FIG. 1;

FIG. 3 is a flow chart showing an authentication processing procedure to be executed in the server according to the embodiment of the present invention;

FIG. 4 is a flow chart showing a restricted screen generating process to be executed in a step S312 shown in FIG. 3;

FIG. 5 is a flow chart showing an access token generation processing procedure to be executed in the server when a transfer button 806 is depressed in a screen operation process to be executed in a step S313 shown in FIG. 3;

FIG. 6 is a flow chart showing an example of a server connection processing procedure to be executed at an operation authority transfer location according to the embodiment of the present invention;

FIG. 7 is a view showing a login screen in a client to be used to perform the login to the server according to the embodiment of the present invention;

FIG. 8 is a view showing an initial screen in the client after performing the login according to the embodiment of the present invention;

FIG. 9 is a view showing an authority transfer screen in the client according to the embodiment of the present invention;

FIG. 10 is a view showing a data format of an access token according to the embodiment of the present invention;

FIG. 11 is a view indicating the embodiment of the present invention and showing an example of an access URL list to be managed in the server;

FIG. 12 is a view indicating the embodiment of the present invention and showing an example of an access ticket list to be managed in the server; and

FIG. 13 is a block diagram indicating the embodiment of the present invention and showing an example of a computer system capable of constituting client terminal apparatuses.

### DETAILED DESCRIPTION OF THE PREFERRED EMBODIMENTS

Hereinafter, the embodiments of the present invention will be explained with reference to the accompanying drawings.

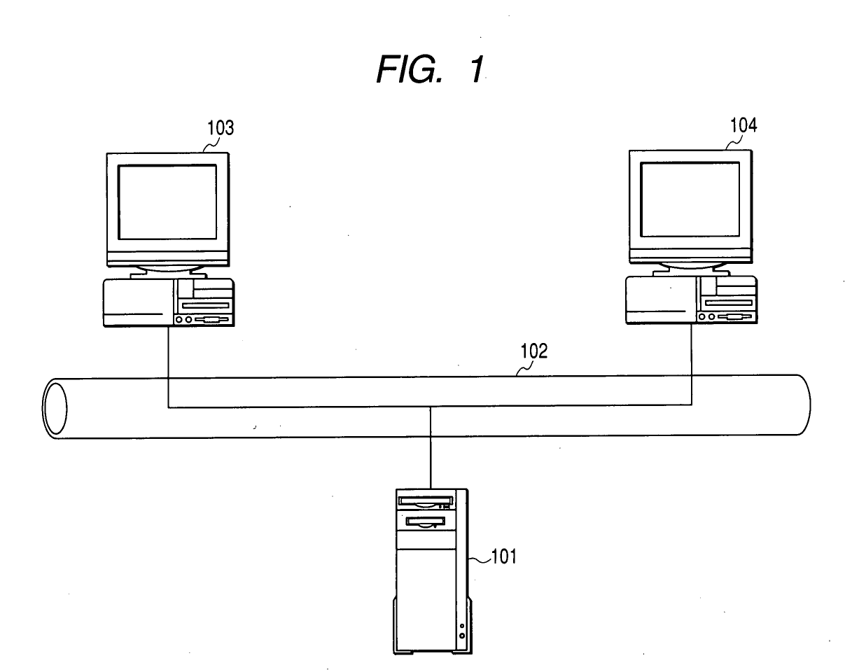

FIG. 1 is a view schematically showing the structure of a system according to the embodiment of the present invention.

In FIG. 1, an information processing apparatus 101 called a server has a large capacity storage apparatus and can process plural transactions at a high speed. The server 101 is connected to a LAN (Local Area Network) 102 and can communicate with a first information processing apparatus 103 and a second information processing apparatus 104 called clients through the LAN 102.

The server 101 operates as a document management server for accumulating and managing image data and document data, and the clients 103 and 104 can access to the image data or the document data accumulated in the server 101 by communicating with the server 101.

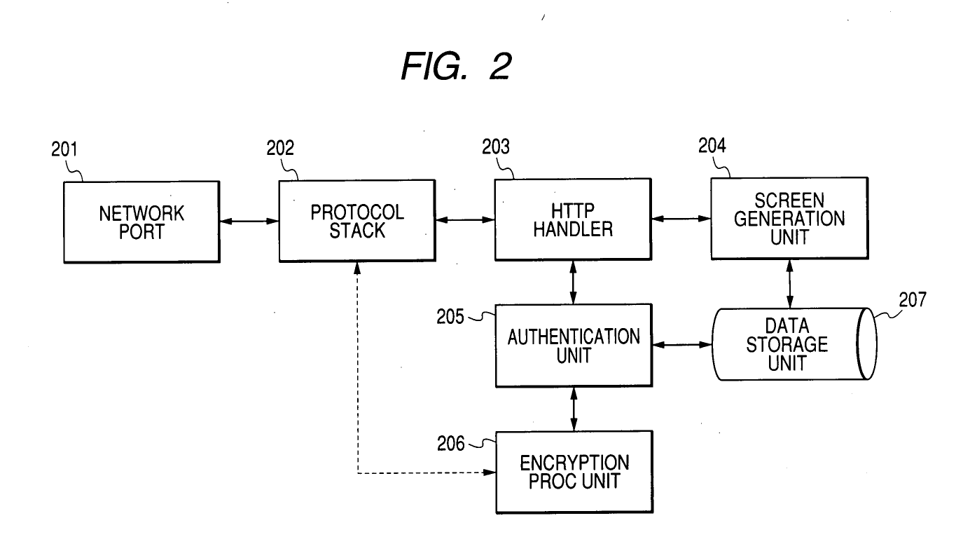

FIG. 2 is a block diagram schematically showing the internal structure of a module group in the server 101 shown in FIG. 1.

In FIG. 2, a network port 201 which is connected to the LAN 102 converts a signal received from the LAN 102 into digital data to transfer it to a protocol stack 202 or converts data received from the protocol stack 202 into a signal to transmit it to the LAN 102.

An HTTP (Hyper Text Transfer Protocol) handler 203 processes the HTTP protocol discriminated in the protocol stack 202. An authentication unit 205 authenticates authentication information transferred from the HTTP handler 203. A screen generation unit 204 generates screen information such as an HTML (Hyper Text Markup Language) on the basis of information stored in a data storage unit 207 according to an instruction from the HTTP handler.

The authentication unit 205 performs decryption of encrypted (or ciphered) data or generation of encrypted data by an encryption processing unit 206. It should be noted that the security of a communication path can be improved in a manner that the protocol stack 202 cooperatively acts with the encryption processing unit 206 as found in the protocol of an SSL (Secure Socket Layer) or a TLS (Transport Layer Security). However, such the securing function is not always required in realizing the present invention.

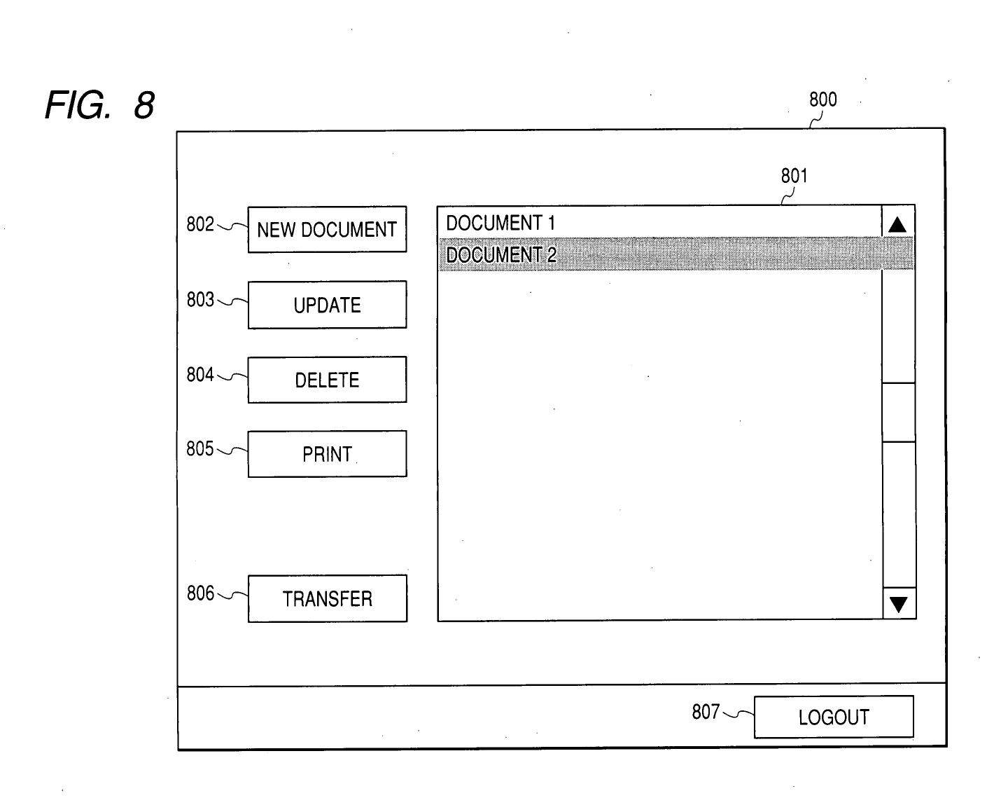

FIG. 8 is a view showing an example of an initial display screen 800 constituted by initial screen information to be transmitted after authenticating login information sent from the client 103 or 104. The initial screen information is generated by the screen generation unit 204 in the server 101 and is transmitted to the client 103 or 104 through the network to be displayed on the client 103 or 104. In the client 103 or 104, when the document is designated and registered by depressing a new document button 802 shown in FIG. 8, the designated document is accumulated in the data storage unit 207 in the server 101, and the accumulated document is displayed on a registered document display column 801. When an update button 803 is depressed, the document selected on the registered document display column 801 can be replaced by a new document.

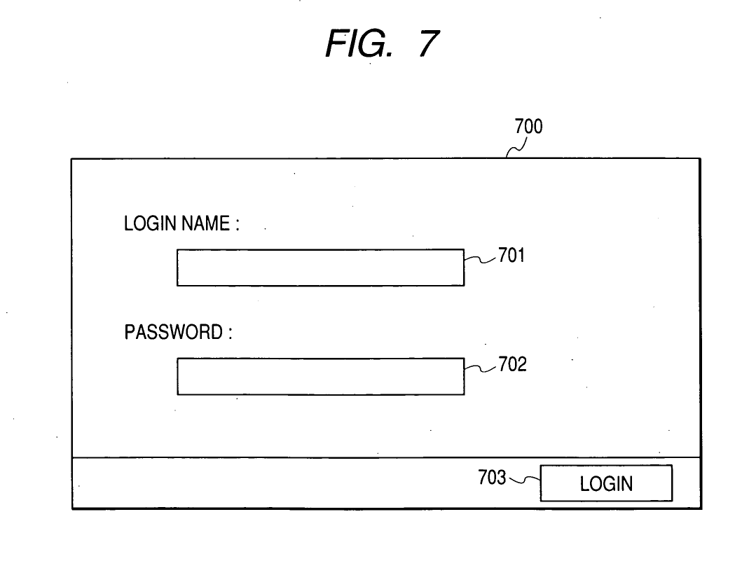

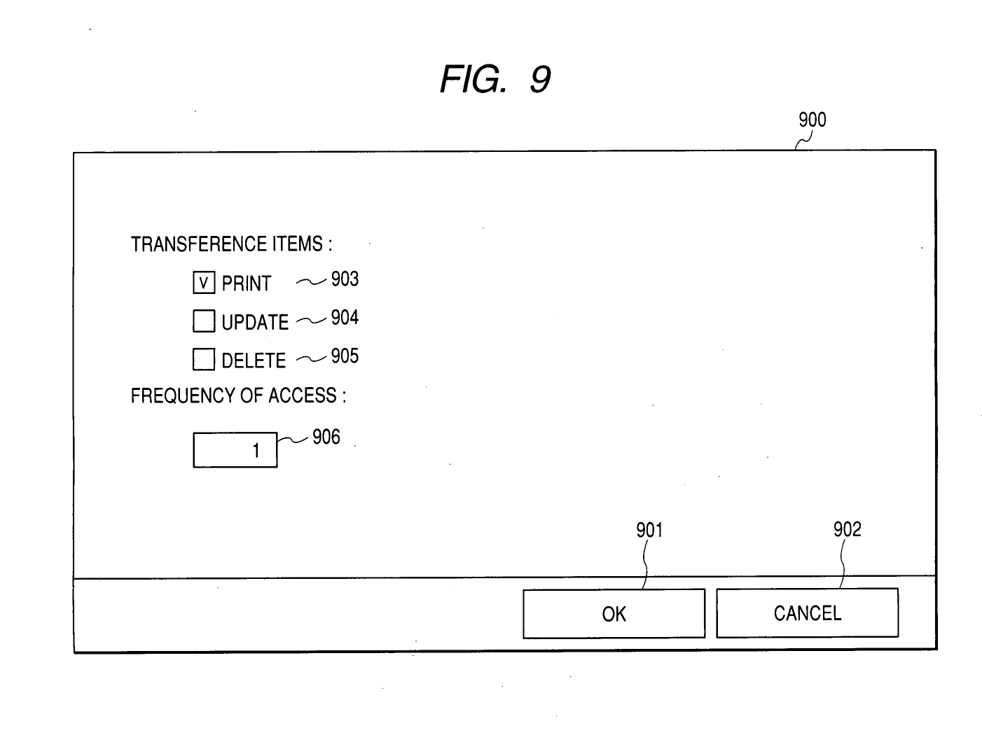

When a deletion button 804 and a print button 805 are depressed, the document selected on the registered document display column 801 can be deleted or printed in response to depression of the respective buttons. When a logout button 807 is depressed, a logout from an authenticated status is performed and a login screen 700 shown in FIG. 7 is displayed. When a transfer button 806 is depressed after selecting the document on the registered document display column 801, an authority transfer screen shown in FIG. 9 is displayed.

FIG. 9 is a view showing a structural example of an authority transfer screen 900. In FIG. 9, a setting for transferring the authority for enabling an operation checked in a check box of print 903, update 904 or deletion 905 enumerated in a transfer items column by only the frequency set in an access frequency input area 906 is performed for the document selected on the screen shown in FIG. 8 by depressing an OK button 901. When a cancel button 902 is depressed, the current setting is canceled to shift to the initial display screen 800 shown in FIG. 8.

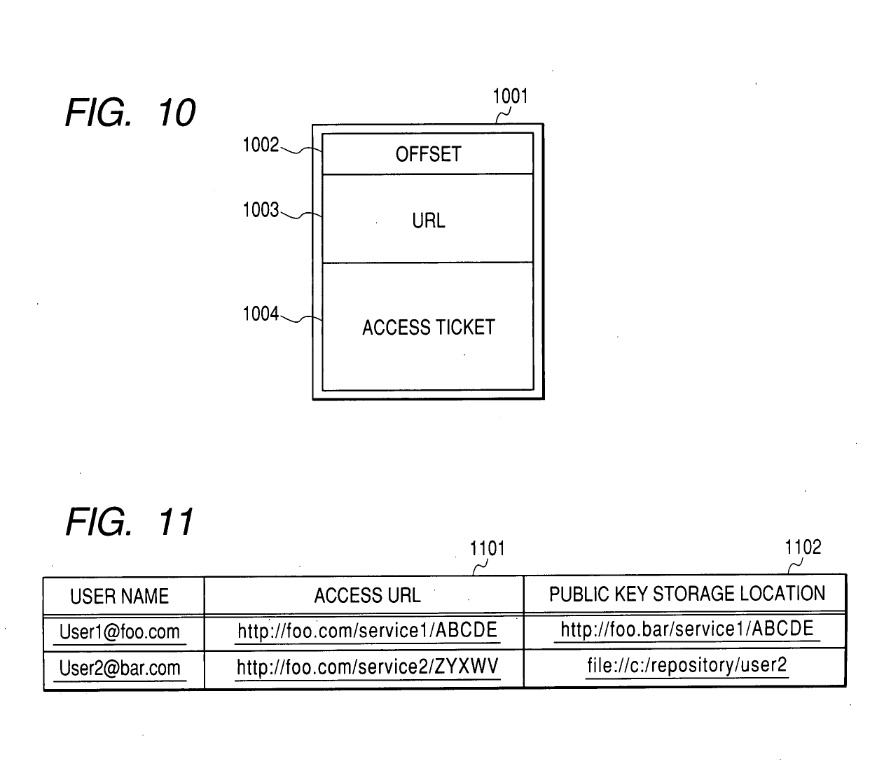

FIG. 10 is a view showing a data format of an access token generated in case of depressing the OK button 901 on the authority transfer screen 900 shown in FIG. 9. An access token 1001 is constituted by an encrypted access ticket 1004, an offset 1002 to the access ticket 1004 and an access URL (Uniform Resource Locator) 1003 for discriminating an access of the authority corresponding to the access ticket 1004 to an operable screen.

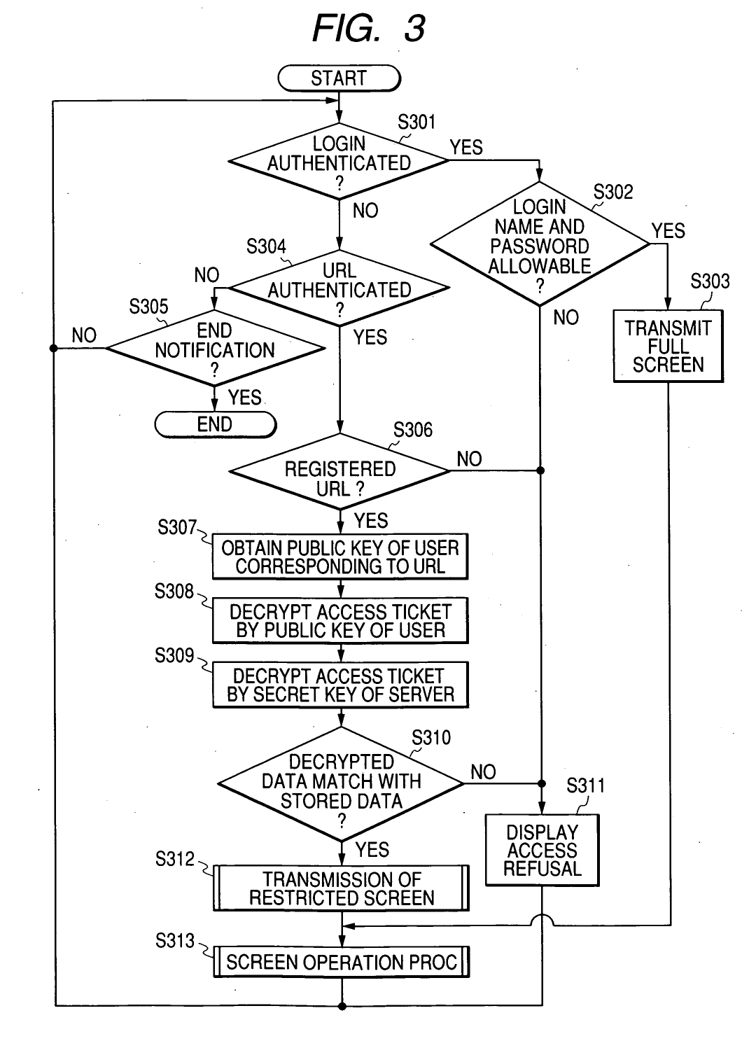

Hereinafter, a concrete example of an object management system according to the present invention will be explained with reference to flow charts shown in FIGS. 3 to 6.

FIG. 3 is a flow chart showing a login process to be executed in the server 101 for realizing the present invention. Generally, when a user registered in the server 101 operates the client 103 or 104 to connect to the server 101, the login screen 700 shown in FIG. 7 is displayed. On that screen, by inputting proper (allowable) login name and password and depressing a login button 703, the login to the server 101 is accomplished and then an operation for the document (object) can be performed.

Initially, in a first step S301, it is judged whether or not the login process was executed from the login screen 700 shown in FIG. 7. As a result of the judgment, when the login process was executed, a flow advances to a step S302, where it is judged whether or not the login name and the password which were input are proper (allowable). As a result of the judgment, when the login name and the password are proper, the flow advances to a step S303, where screen (full screen) information, which is like the initial display screen 800 shown in FIG. 8, capable of performing all the operations for the object is generated and transmitted. With respect to the screen information, such a format which can be easily displayed on the screen at a side of the client terminal apparatus (user) such as the HTML (Hyper Text Markup Language) is desired. However, it is not especially limited to the HTML.

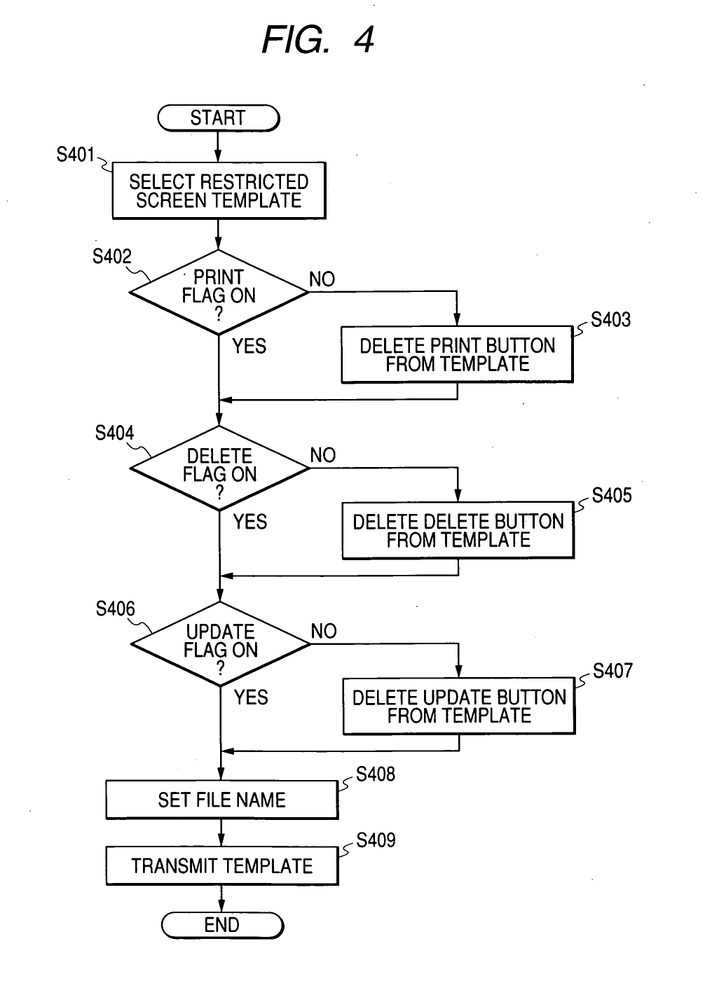

After transmitting the full screen information in the step S303, the flow advances to a step S313, where a process regarding the operation performed to the screen information is executed. An example of this process will be described later using a flow chart shown in FIG. 4.

On the other hand, as a result of the judgment judged in the step S302, when the input information is different from the registered information, the flow advances to a step S311, where screen information of notifying that an access to the server 101 is refused is generated and transmitted and then the flow returns to the process in the step S301.

Meanwhile, in the step S301, when it is judged that the login process is not executed from the login screen, the flow advances to a step S304, where it is judged whether or not a connecting process is executed to a URL (access URL), which is used for connecting to the server 101 by the restricted operation authority, as indicated by an access URL 1101 shown in FIG. 11. As a result of the judgment, when the connecting process to the access URL was not executed, the flow advances to a step S305, where it is judged whether or not an end notification is sent. When the end notification was sent, the process is terminated, and when the end notification was not sent, the flow returns to the process in the step S301. The end notification indicates that an ending process was executed to the program of realizing the present invention by a server administrator or the like.

As a result of the judgment judged in the step S304, when it is judged that the connecting process to the access URL is executed, the flow advances to a step S306, where a list as shown in FIG. 11 is searched, and it is judged whether or not a connected URL is registered in the list as the access URL. When the connected URL is not registered in the list, the flow advances to the step S311, and when the connected URL is registered in the list, the flow advances to a step S307.

In the step S307, a public key is obtained from a storage area of the public key of a user corresponding to the access URL, as indicated by a public key storage location 1102 shown in FIG. 11. Then, in a step S308, the received access ticket (corresponds to a reference numeral 1004 in FIG. 10) is decrypted at the same time of the connection to the access URL by using the obtained public key.

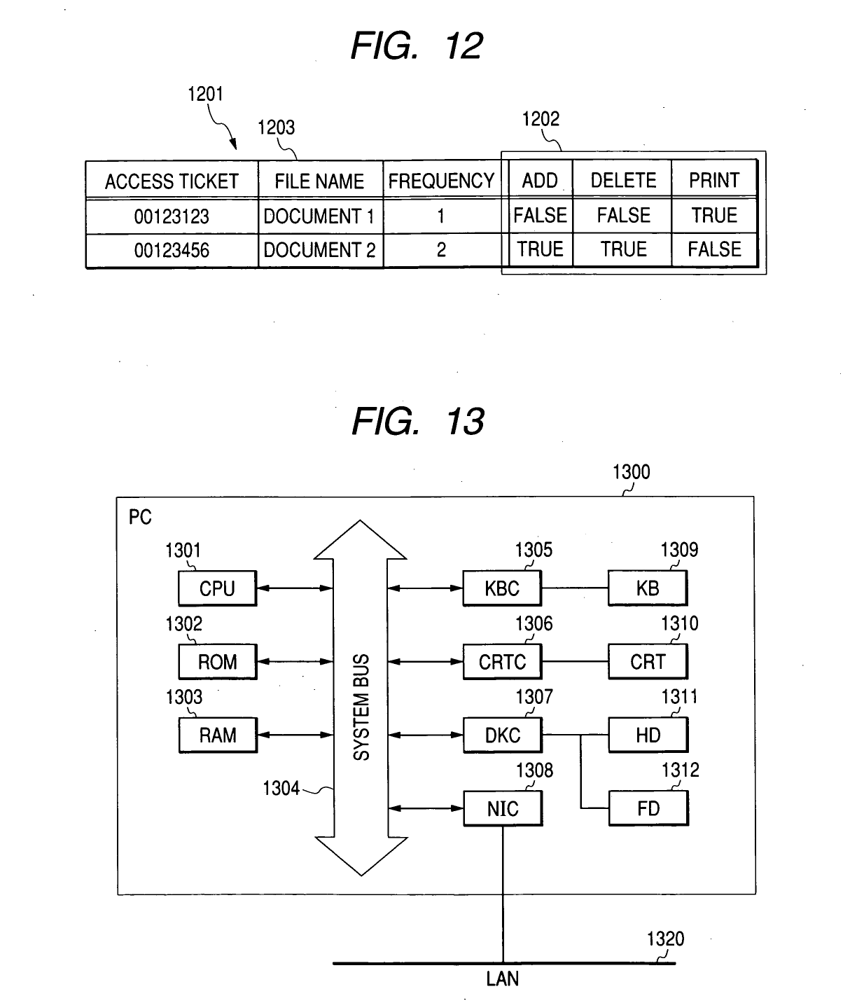

Subsequently, in a step S309, the decrypted data is further decrypted by using a secret key of the server 101. Next, in a step S310, it is judged whether or not the data decrypted in the step S309 is registered in an access ticket list 1201 shown in FIG. 12. As a result of the judgment, when that decrypted data is not registered in the access ticket list 1201, the flow advances to the step S311, and when that decrypted data is registered, the flow advances to a step S312. In the step S312, a restricted screen to be described later is generated and then a transmitting process is executed. Thereafter, the flow advances to an operating process procedure corresponding to the screen to be executed in the step S313.

In the step S304, when it is judged that the connecting process to the access URL was executed, the access ticket 1004 as shown in FIG. 10 is received. The access ticket 1004 is encrypted by the secret key of the server 101 generated by using a common key encryptosystem such as a DES (Data Encryption Standard), thereafter further encrypted by a private key of an owner generated by using a public key cryptosystem such as an RSA (Rivest Shamir Adleman) by the owner of a file.

In the above-mentioned public key cryptosystem, data encrypted by a certain private key can not be decrypted unless a public key corresponding to the private key is used. Conversely, data which is to be normally decrypted by a certain public key has to be encrypted by a private key corresponding to the public key. Therefore, when the data received in the step S304 was such the data of incorrectly generated, the data decrypted in the steps S308 and S309 becomes unjust data.

FIG. 4 is a flow chart showing a restricted screen generating process to be executed in the step S312 shown in FIG. 3, and this process is to be executed in the server 101.

When the restricted screen generating process is started, in an initial step S401, a restricted screen template being a model of the restricted screen stored in the data storage unit 207 in the server 101, is selected. The restricted screen template is previously prepared by using a screen information format such as the HTML and is registered in the data storage unit 207 in the server 101. The restricted screen template is such screen information of generating a screen of removed the transfer button 806 from the initial display screen 800 as shown in FIG. 8.

Next, a flow advances to a step S402, where it is judged whether or not a print flag is in an ON status. With respect to the status of the print flag, it is judged based on a fact whether or not “TRUE” is written in a print column in an access flag column 1202 as shown in FIG. 12 corresponding to the access ticket 1004 decrypted in the step S309 shown in FIG. 3. As a result of the judgment, if the print flag is not in the ON status (if “FALSE” is written in the print column), the flow advances to a step S403, where information related to a print button is deleted from the template selected in the step S401.

As a result of the judgment judged in the step S402, when the print flag is in the ON status, the flow advances to a step S404, where it is judged whether or not a delete flag is in an ON status. As a result of the judgment, if the delete flag is not in the ON status, the flow advances to a step S405, where information related to a delete button is deleted from the template. As a result of the judgment judged in the step S404, when the delete flag is in the ON status, the flow advances to a step S406.

In the step S406, it is judged whether or not an update flag is in an ON status. When the update flag is not in the ON status, the flow advances to a step S407, where information related to the update button is deleted. Thereafter the flow advances to a step S408. On the other hand, as a result of the judgment judged in the step S406, when the update flag is in the ON status, the flow advances to the step S408.

In the step S408, a file name corresponding to the access ticket is obtained from a file name column 1203 shown in FIG. 12 to set to information corresponding to a document table of the template. Thereafter, the flow advances to a step S409, where template information is transmitted to an information processing apparatus (a client terminal apparatus) to be connected to the network. Thereby, a screen capable of operating only the transferred authority corresponding to the access ticket is to be displayed on the client terminal apparatus.

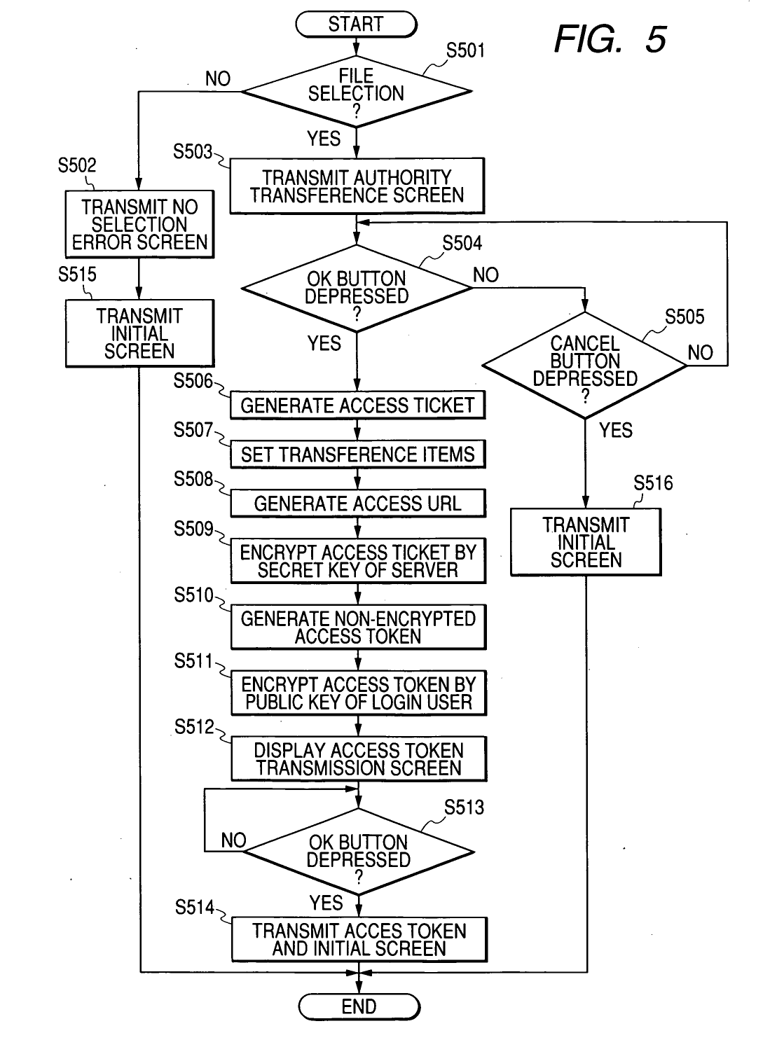

FIG. 5 is a flow chart showing a process when the transfer button 806 shown in FIG. 8 is depressed in the screen operation process indicated in the step S313 in the flow chart shown in FIG. 3.

When the process is started, in an initial step S501, it is judged whether or not the document is selected on the registered document display column 801 shown in FIG. 8. As a result of the judgment, when the document is not selected, the flow advances to a step S502, where non-selection error screen information is transmitted. Thereafter, in a step S515, an initial screen is transmitted and then the process is terminated. As a result of the judgment judged in the step S501, when the document is selected, the flow advances to a step S503, where such screen information of displaying the authority transfer screen 900 as shown in FIG. 9 is transmitted.

Next, the flow advances to the step S504, where it is judged whether or not the OK button 901 shown in FIG. 9 is depressed. When the OK button 901 is not depressed, the flow advances to the step S505, where it is judged whether or not the cancel button 902 is depressed. As a result of the judgment, when the cancel button is not depressed, the flow returns to a process to be executed in the step S504. When the cancel button 902 is depressed, in a step S516, initial screen information is transmitted and then the process is terminated.

On the other hand, as a result of the judgment judged in the step S504, when the OK button 901 is depressed, the flow advances to a step S506, where the access ticket 1004 shown in FIG. 10 is generated and is added to the access ticket list 1201 shown in FIG. 12. The access ticket 1004 is an arbitrary byte-row never overlapped in an activating status of the server 101.

Next, in a step S507, transference items are set. In the setting of the transference items, “TRUE” is set in an access flag column of the access ticket list 1201 shown in FIG. 12 corresponding to an item checked in a check box in the transference items column shown in FIG. 9, and “FALSE” is set in an access flag column corresponding to an item which is not checked in a check box.

In a next step S508, an access URL is generated and is added to the list of the access URL shown in FIG. 11. Next, in a step S509, the access ticket generated in the step S506 is encrypted by a secret key of the server 101 generated by using the common key encryptosystem such as the DES.

Subsequently, in a step S510, a non-encrypted access token 1001, which is obtained by combining the offset to the access ticket, the access URL generated in the step S508 and the access ticket encrypted in step S509, shown in FIG. 10 is generated.

Subsequently, the flow advances to a step S511, where a public key corresponding to a connecting user is obtained on the basis of information described in the list shown in FIG. 11 and then the non-encrypted access token 1001 is encrypted by using the obtained public key.

Here, it is assumed that a public key of a user capable of performing the login to the server 101, that is, the user whose login name is registered, is previously registered in the data storage unit 207 of the server 101 in a state that the public key is corresponded with the user.

Subsequently, in a step S512, access token storage screen information, wherein such information of urging to store the encrypted access token in the client 103 or 104 being used by the connecting user is described, is transmitted. Next, in a step S513, it is judged whether or not the OK button on the screen is depressed in the client, which received the access token storage screen information. When it is judged that the OK button is depressed, in a step S514, the initial screen information shown in FIG. 8 is transmitted after transmitting the access token to the client terminal apparatus and then the process is terminated.

When the user transfers the operation authority to a third party, an operation explained below is performed.

In a case that the user, who received the access token, wants to transfer the operation authority set in the access token to the third party, initially the access token is decrypted by using an own private key. Then, the access ticket is extracted from the decrypted access token, and the extracted access ticket is encrypted by using the own private key and then the non-encrypted access token 1001 is generated by combining the offset 1002 with the access URL 1003. Thereafter, the non-encrypted access token 1001 is encrypted by using a public key of the third party (other party to whom the operation authority is transferred) and then the operation authority is transferred to the third party by using an E-mail or the like.

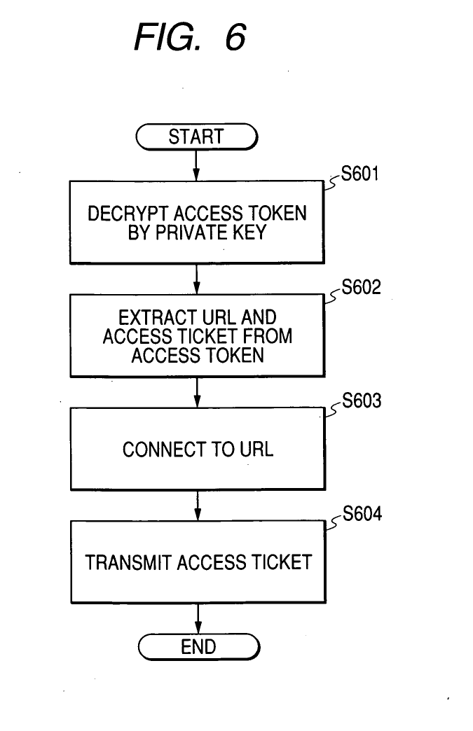

FIG. 6 is a flow chart of a server connection processing procedure using the access token in the client, which received the access token encrypted by the public key of the third party to whom the operation authority is transferred.

The third party, who received the access token, decrypts the access token by the own private key in a step S601. Thereafter, the access URL 1003 and the access ticket 1004 are separately extracted from the access token in a step S602. Next, a process of connecting to the URL is executed in a step S603 and then, in a step S604, the access ticket 1004 is transmitted. Here, since the access ticket is encrypted by the secret key of the server 101 and further encrypted by the private key of the user, who transfers the operation authority, the contents of the access ticket can not be modified by the third party to whom the operation authority is transferred.

The server 101, to which the access URL is connected, can transmit screen information capable of performing an operation corresponding to the access ticket to the third party by executing processes following the steps S306 to S313 shown in FIG. 3. Accordingly, the authority of performing a specific operation is to be transferred to the third party.

Here, assuming that the third party, to whom the accessing authority was transferred, has been known the secret key of the server 101, even if the third party can rewrite the contents of the access ticket by decrypting the access ticket by use of the secret key and the public key of the user who transfers the operation authority, since the modified access ticket can not be encrypted using the private key of the user who transfers the operation authority, if the modified access ticket is connected to the access URL and is transmitted, it can be judged that the ticket is not proper in the step S310 shown in FIG. 3. Thereby, the security for the access ticket can be ensured.

FIG. 13 is a block diagram showing an example of a computer system capable of constituting the client terminal apparatuses 103 and 104.

In FIG. 13, a computer PC 1300 which includes a CPU 1301 executes apparatus control software stored in a ROM 1302 or a hard disk (HD) 1311 or supplied from a flexible disk drive (FD) 1312 and synthetically controls the respective apparatuses connected to a system bus 1304.

Respective functional means of the embodiment in the present invention are constituted by programs stored in the CPU 1301, the ROM 1302 and the hard disk (HD) 1311 of the PC 1300.

A RAM 1303 functions as a main memory, a work area and the like of the CPU 1301. A keyboard controller (KBC) 1305 controls to input signals, which are input from a keyboard (KB) 1309, into the substance of the system. A display controller (CRTC) 1306 performs a display control on a display apparatus (CRT) 1310. A disk controller (DKC) 1307 controls to access to the hard disk (HD) 1311, which stores a boot program (an activation program for starting an execution (operation) of the software or the hardware of a personal computer), plural applications, an editing file, a user file, a network managing program and the like, and to the flexible disk (FD) 1312.

A network interface card (NIC) 1308 performs an interactive exchange of data with a network printer, other network apparatuses or another PC through a LAN 1320. The data storage unit 207 of the server 101 shown in FIG. 2 corresponds to the hard disk 1311 shown in FIG. 13.

As explained above, according to an object management system of the embodiment in the present invention, an access ticket corresponding to the transfer authority and an access URL corresponding to a registered user are generated and managed for an authority transfer request of a designated file instructed from the registered user in the server 101, and after the access ticket is encrypted by a secret key held by the server 101, offset information and the access URL is combined (called an access token), and the access token is encrypted by a public key of the registered user and then the encrypted data is transmitted to the user.

When the user, who received the access token, desires to transfer a specific operation of a file on the server 101 associated with the access token to the third party, the access token is decrypted by the own private key to extract the access ticket included in the access token and then the access ticket is encrypted by the own private key. Thereafter, the access ticket, to which the access URL and the offset information are added, is returned to the access token, and the entire access token is encrypted by a public key of the third party, to whom the specific operation authority is transferred, then the encrypted access token is transmitted to the third party to whom the specific operation authority is to be transferred.

The third party decrypts the access token by the own private key and separates the decrypted access token into the access URL 1003 and the access ticket 1004. Subsequently, the access ticket 1004 is transmitted by connecting to the access URL.

When the access ticket 1004 is received, the server 101 decrypts the access ticket by using the public key of the user associated with the access URL and then searches data further decrypted by the own secret key from the list. Thereby, screen information capable of performing the specific operation of a file associated with the access ticket is transmitted to the third party. Accordingly, the third party can specify the file associated with the access ticket.

In this case, in the object management system of the present embodiment, since the access ticket is encrypted and then is to be transmitted, authority transfer data can be safely transmitted and received between the server 101 and the registered user, between the registered user and the third party to whom the operation authority is transferred, and between the third party and the server 101.

Incidentally, other embodiments of the present invention will be explained hereinafter.

The present invention also includes a case where the program codes of software for realizing the functions of the above-mentioned embodiment are supplied to an apparatus connected to the various apparatuses or a computer in a system so as to operate the various apparatuses to realize the functions of the above-mentioned embodiment, and the functions are embodied by operating the various apparatuses in accordance with the programs stored in the computer (or CPU or MPU) in the system or the apparatus.

In this case, the program codes themselves of the software realize the functions of the above-mentioned embodiment, and the program codes themselves and the means for supplying the program codes to the computer, for example, a storage medium storing such the program codes constitute the present invention. As the recording medium for recording the program codes, for example, a flexible disk, a hard disk, an optical disk, a magnetooptical disk, a CD-ROM, a magnetic tape, a nonvolatile memory card, a ROM or the like can be used.

Such the program codes are included in the embodiment of the present invention not only in a case where the functions of the above-mentioned embodiment are realized by the execution of the program codes supplied to the computer, but also in a case where the functions of the above-mentioned embodiment are realized by such the program codes which cooperate with an OS (operating system) functioning on the computer, another application software or the like.

Further, the present invention includes a case where the supplied program codes are once stored in a memory provided in a function expansion board inserted in the computer or a function expansion unit connected to the computer, then a CPU or the like provided in the function expansion board or the function expansion unit executes all the process or a part thereof according to the instructions of such the program codes, thereby realizing the functions of the above-mentioned embodiment.

Still further, in the embodiment of the present invention, it has been explained that a public key cryptosystem such as the RSA (Rivest Shamir Adleman) is used in transferring the access token, which is then encrypted by using a public key of the other party to whom the access token is transferred. However, as another method, such a method, wherein a secret key by a common key encryptosystem such as the DES (Data Encryption Standard) or a triple DES is generated in one time, and the access token is encrypted by the one-time shared key and further the one-time shared key is encrypted by using the public key of the other party to whom the access token is transferred, thereafter the shared-key encrypted access token and the public-key encrypted shared key are transmitted to the other party to whom the access token is transferred, may be used.

In this case, at a side of the other party to whom the access token is transferred, the shared key is decrypted by using the own private key, and the access token can be decrypted by using the decrypted shared key.

As above, although the present invention has been explained on the basis of preferable examples of the embodiment, the present invention is not limited to the present embodiment but can be variously modified within the scope of the appended claims.

This application claims priority from Japanese Patent Application No. 2003-397756 filed Nov. 27, 2003, which is hereby incorporated by reference herein.

1. A server apparatus which stores and administrates an object and operation authority information for the object, and limits that a first client terminal connected through a network performs an operation to the object on the basis of the operation authority information corresponding to a user of the first client terminal, said server apparatus comprising:
a receiving unit adapted to receive, from the first client terminal, an operation authority transference request including transference operation information indicating the content of operation authority to be transferred;
an access token generation unit adapted to generate an access token based on the transference operation information included in the operation authority transference request, in response to the reception of the operation authority transference request by said receiving unit; and
a transmitting unit adapted to transmit the access token to the first client terminal.

2. A server apparatus according to claim 1, further comprising an authentication unit adapted to authenticate the user of the first client terminal,
wherein the access token includes an access URL (Uniform Resource Locator) for specifying the user of the first client terminal authenticated by said authentication unit and an access ticket indicating the transference operation information.

3. A server apparatus according to claim 2, further comprising an encryption unit adapted to encrypt the access ticket by using an own secret key.

4. A server apparatus according to claim 1, further comprising a control unit adapted to permit, on the basis of the access token received by said receiving unit from a second client terminal different from the first client terminal, the second client terminal to perform the operation to the object.

5. A server apparatus according to claim 4, wherein
the access token includes an access URL for specifying the user of the first client terminal authenticated by said authentication unit and an access ticket indicating the transference operation information,
said control unit judges whether or not the access URL included in the access token transmitted from the second client terminal and received by said receiving unit is allowable,
when it is judged by said control unit that the access URL included in the received access token is allowable, said control unit permits the access from the second client terminal on the basis of the transference operation information indicated by the access ticket, and
when it is judged by said control unit that the access URL included in the received access token is not allowable, said control unit refuses the access from the second client terminal.

6. A server apparatus according to claim 5, wherein the access ticket included in the access token transmitted from the second client terminal and received by said receiving unit is encrypted by using a private key of the user of the first client terminal.

7. A server apparatus according to claim 4, wherein said control unit transmits, to the second client terminal, an operation screen for limiting the operation to the object on the basis of the access token transmitted from the second client terminal.

8. A terminal apparatus which can be connected to a network, comprising:
a communication unit adapted to communicate with a server apparatus through the network;
a display unit adapted to display a screen based on screen generation information received from the server apparatus by said communication unit;
an input unit adapted to input operation information including an operation authority transference operation to the screen displayed by said display unit;
an operation information transmitting unit adapted to transmit by using said communication unit the operation information input by said input unit to the server apparatus connected to the network;
a receiving unit adapted to receive an access token from the server apparatus through said communication unit;
a decryption unit adapted to decrypt the access token received by said receiving unit, by using a predetermined encryption key;
a first encryption unit adapted to encrypt authority reference information included in the access token decrypted by said decryption unit, by using a predetermined encryption key;
a second encryption unit adapted to encrypt the access token of which the authority reference information has been encrypted by said first encryption unit, by using a public key of an authority transference destination; and
an access token transmitting unit adapted to transmit the access token encrypted by said second encryption unit to a client terminal apparatus of the authority transference destination by using said communication unit.

9. A client terminal apparatus which can be connected to a network, comprising:
a receiving unit adapted to receive an access token, transmitted through the network, including an access URL and an access ticket;
a decryption unit adapted to decrypt the access token received by said receiving unit, by using an own private key; and
a transmitting unit adapted to connect to a server apparatus indicated by the access URL on the network extracted from the access token decrypted by said decryption unit and transmit the access ticket extracted from the access token to the server apparatus.

10. An object administration system comprising:
a first client terminal connected to a network;
a second client terminal connected to the network; and
a server apparatus which stores and administrates an object and operation authority information for the object, and limits that the first client terminal or the second client terminal connected through a network performs an operation to the object on the basis of the operation authority information corresponding to a user of the first client terminal or the second client terminal, wherein
the first client terminal comprises:
a communication unit adapted to communicate with the server apparatus and the second client terminal through the network;
an operation authority transference request transmitting unit adapted to transmit by using said communication unit an operation authority transference request including transference operation information indicating the content of operation authority to be transferred to the server apparatus connected to the network;
an access token receiving unit adapted to receive an access token including an access URL and an access ticket from the server apparatus through said communication unit; and
an access token transmitting unit adapted to transmit the access token to the second client terminal of the authority transference destination by using said communication unit,
the server apparatus comprises:
a receiving unit adapted to receive the operation authority transference request from the first client terminal and the access ticket from the second client terminal;
an access token generation unit adapted to generate the access token based on the transference operation information included in the operation authority transference request, in response to the reception of the operation authority transference request by the receiving unit;
a transmitting unit adapted to transmit the access token to the first client terminal; and
an operation authority administrating unit adapted to administrate the operation authority information for limiting the operation authority by the second client terminal to the object, based on the access ticket received from the second client terminal by the receiving unit, and
the second client terminal comprises:
an access token receiving unit adapted to receive the access token, transmitted from the first client terminal through the network; and
an access ticket transmitting unit adapted to connect to the server apparatus indicated by the access URL on the network extracted from the access token and transmit the access ticket extracted from the access token to the server apparatus.

11. A server apparatus which stores and administrates an object and operation authority information for the object, and limits that a first client terminal connected through a network performs an operation to the object on the basis of the operation authority information corresponding to a user of the first client terminal, said server apparatus comprising:
receiving means for receiving, from the first client terminal, an operation authority transference request including transference operation information indicating the content of operation authority to be transferred;
access token generating means for generating an access token based on the transference operation information included in the operation authority transference request, in response to the reception of the operation authority transference request by said receiving means; and
transmitting means for transmitting the access token to the first client terminal.

12. A terminal apparatus which can be connected to a network, comprising:
communication means for communicating with a server apparatus through the network;
display means for displaying a screen based on screen generation information received from the server apparatus by said communication means;
input means for inputting operation information including an operation authority transference operation to the screen displayed by said display means;
operation information transmitting means for transmitting by using said communication means the operation information input by said input means to the server apparatus connected to the network;
receiving means for receiving an access token from the server apparatus through said communication means;
decryption means for decrypting the access token received by said receiving means, by using a predetermined encryption key;
first encryption means for encrypting authority reference information included in the access token decrypted by said decryption means, by using a predetermined encryption key;
second encryption means for encrypting the access token of which the authority reference information has been encrypted by said first encryption means, by using a public key of an authority transference destination; and
an access token transmitting means for transmitting the access token encrypted by said second encryption means to a client terminal apparatus of the authority transference destination by using said communication means.

13. A client terminal apparatus which can be connected to a network, comprising:
receiving means for receiving an access token, transmitted through the network, including an access URL and an access ticket;
decryption means for decrypting the access token received by said receiving means, by using an own secret key; and
transmitting means for connecting to a server apparatus indicated by the access URL on the network extracted from the access token decrypted by said decryption means and transmit the access ticket extracted from the access token to the server apparatus.

14. An object administration method for a server apparatus which stores and administrates an object and operation authority information for the object, and limits that a first client terminal connected through a network performs an operation to the object on the basis of the operation authority information corresponding to a user of the first client terminal, said method comprising:
a receiving step of receiving, from the first client terminal, an operation authority transference request including transference operation information indicating the content of operation authority to be transferred;
an access token generation step of generating an access token based on the transference operation information included in the operation authority transference request, in response to the reception of the operation authority transference request in said receiving step; and
a transmitting step of transmitting the access token to the first client terminal.

15. An object administration method for a terminal apparatus which can be connected to a network, said method comprising:
a communication step of communicating with a server apparatus through the network;
a display step of displaying a screen based on screen generation information received from the server apparatus in said communication step;
an input step of inputting operation information including an operation authority transference operation to the screen displayed in said display step;
an operation information transmitting step of transmitting the operation information input in said input step to the server apparatus connected to the network;
an access token receiving step of receiving an access token from the server apparatus;
a decryption step of decrypting the access token received in said access token receiving step, by using a predetermined encryption key;
a first encryption step of encrypting authority reference information included in the access token decrypted in said decryption step, by using a predetermined encryption key;
a second encryption step of encrypting the access token of which the authority reference information has been encrypted in said first encryption step, by using a public key of an authority transference destination; and
an access token transmitting step of transmitting the access token encrypted in said second encryption step to a client terminal apparatus of the authority transference destination.

16. An object administration method for a client terminal apparatus which can be connected to a network, said method comprising:
a receiving step of receiving an access token, transmitted through the network, including an access URL and an access ticket;
a decryption step of decrypting the access token received in said receiving step, by using an own private key; and
a transmitting step of connecting to a server apparatus indicated by the access URL on the network extracted from the access token decrypted in said decryption step and transmitting the access ticket extracted from the access token to the server apparatus.

17. A computer program for causing a computer to execute an object administration method for a server apparatus which stores and administrates an object and operation authority information for the object, and limits that a first client terminal connected through a network performs an operation to the object on the basis of the operation authority information corresponding to a user of the first client terminal, said method comprising:
a receiving step of receiving, from the first client terminal, an operation authority transference request including transference operation information indicating the content of operation authority to be transferred;
an access token generation step of generating an access token based on the transference operation information included in the operation authority transference request, in response to the reception of the operation authority transference request in said receiving step; and
a transmitting step of transmitting the access token to the first client terminal.

18. A computer program for causing a computer to execute an object administration method for a terminal apparatus which can be connected to a network, said method comprising:
a communication step of communicating with a server apparatus through the network;
a display step of displaying a screen based on screen generation information received from the server apparatus in said communication step;
an input step of inputting operation information including an operation authority transference operation to the screen displayed in said display step;
an operation information transmitting step of transmitting the operation information input in said input step to the server apparatus connected to the network;
an access token receiving step of receiving an access token from the server apparatus;
a decryption step of decrypting the access token received in said access token receiving step, by using a predetermined encryption key;
a first encryption step of encrypting authority reference information included in the access token decrypted in said decryption step, by using a predetermined encryption key;
a second encryption step of encrypting the access token of which the authority reference information has been encrypted in said first encryption step, by using a public key of an authority transference destination; and
an access token transmitting step of transmitting the access token encrypted in said second encryption step to a client terminal apparatus of the authority transference destination.

19. A computer program for causing a computer to execute an object administration method for a client terminal apparatus which can be connected to a network, said method comprising:
a receiving step of receiving an access token, transmitted through the network, including an access URL and an access ticket;
a decryption step of decrypting the access token received in said receiving step, by using an own private key; and
a transmitting step of connecting to a server apparatus indicated by the access URL on the network extracted from the access token decrypted in said decryption step and transmitting the access ticket extracted from the access token to the server apparatus.

20. A computer-readable storage medium which stores computer program for causing a computer to execute an object administration method for a server apparatus which stores and administrates an object and operation authority information for the object, and limits that a first client terminal connected through a network performs an operation to the object on the basis of the operation authority information corresponding to a user of the first client terminal, said method comprising:
a receiving step of receiving, from the first client terminal, an operation authority transference request including transference operation information indicating the content of operation authority to be transferred;
an access token generation step of generating an access token based on the transference operation information included in the operation authority transference request, in response to the reception of the operation authority transference request in said receiving step; and
a transmitting step of transmitting the access token to the first client terminal.

21. A computer-readable storage medium which stores computer program for causing a computer to execute an object administration method for a terminal apparatus which can be connected to a network, said method comprising:
a communication step of communicating with a server apparatus through the network;
a display step of displaying a screen based on screen generation information received from the server apparatus in said communication step;
an input step of inputting operation information including an operation authority transference operation to the screen displayed in said display step;
an operation information transmitting step of transmitting the operation information input in said input step to the server apparatus connected to the network;
an access token receiving step of receiving an access token from the server apparatus;
a decryption step of decrypting the access token received in said access token receiving step, by using a predetermined encryption key;
a first encryption step of encrypting authority reference information included in the access token decrypted in said decryption step, by using a predetermined encryption key;
a second encryption step of encrypting the access token of which the authority reference information has been encrypted in said first encryption step, by using a public key of an authority transference destination; and
an access token transmitting step of transmitting the access token encrypted in said second encryption step to a client terminal apparatus of the authority transference destination.

22. A computer-readable storage medium which stores computer program for causing a computer to execute an object administration method for a client terminal apparatus which can be connected to a network, said method comprising:
a receiving step of receiving an access token, transmitted through the network, including an access URL and an access ticket;
a decryption step of decrypting the access token received in said receiving step, by using an own secret key; and
a transmitting step of connecting to a server apparatus indicated by the access URL on the network extracted from the access token decrypted in said decryption step and transmitting the access ticket extracted from the access token to the server apparatus.
